(19) United States
(12) Patent Application Publication
(10) Pub. No.: US 2017/0213272 A1
(43) Pub. Date: Jul. 27, 2017

(54) COMPUTER RESOURCE RANKING FOR INTERCONNECTED USER PROFILES

(71) Applicant: Microsoft Technology Licensing, LLC, Redmond, WA (US)

(72) Inventors: David Mowatt, Dublin (IE); David Pierre Claux, Redmond, WA (US); Krister Mikalsen, Tromsø (NO)

(73) Assignee: Microsoft Technology Licensing, LLC, Redmond, WA (US)

(21) Appl. No.: 15/006,317

(22) Filed: Jan. 26, 2016

(51) Int. Cl. G06Q 30/06; G06F 17/30

(52) U.S. Cl. CPC G06Q 30/0631; G06F 17/30867

(57) ABSTRACT

The following indications can be collected: indications of strength of connection between interconnected user profile pairs for an active user profile and another user profile; indications of strength of affinity within user profile-computer resource pairs; and indications of a global level of affinity of a global group of user profiles for computer resources. Using these indications, the following values can be generated: a connection strength value for each of the user profile pairs; an affinity strength value for each of the user profile-computer resource pairs; and a global affinity level value for each of the resources. These values can be used to rank the resources, which can include generating a ranked resource data structure to be used in providing resource recommendations. Values representing usage of a computer resource by sub-groups of user profiles can be generated and a description of a comparison between the values can be provided.

### BACKGROUND

Computer stores use various techniques to suggest computer resources that may be useful or desirable to a particular user profile. Computer systems often provide suggestions for applications that are generally popular, such as software applications in an application store that are generally popular, or on-line shopping items that are generally popular. Computer system can also determine that customers who choose one computer resource also tend to choose one or more other specific computer resources as well (e.g., users who download application A tend to download applications B and C as well), and can suggest those other resources. These types of suggestions have also been applied upon determining that customers who choose resources of one category also choose resources of another category, so that resources of that other category can be suggested by the computer system. As another example, computer systems have tracked usage of documents by user profiles, so that a user profile can receive suggestions of documents used by other user profiles with connections to that user profile in a group of user profiles in a computer system. Such systems have scored the strength of connection between a current user profile for which suggestions are to be made, and other user profiles. That scoring of connection strength has been used, along with scores representing the user profiles' usage of the documents, to rank the documents for purposes of identifying and sorting documents to suggest to the current user.

### SUMMARY

Some tools and techniques discussed herein relate to improvements in ranking of computer resources based on indications of interconnected computer-readable user profiles having an affinity for or usage of those resources. Examples of such computer resources can include, but are not limited to, computer software applications (e.g., stand-alone applications or add-in applications) computer software documents such as document templates, word processing documents, spreadsheet templates, image documents, Web pages, etc.; and computer hardware such as server resources or printers. There are many other possibilities for such computer resources. As used herein, a user profile is a collection of computer-readable data that is configured to represent an individual user or group of users. References to actions performed by a user profile refer to actions performed by computer system components (hardware and possibly software running on the hardware), wherein the user profile is active. For example, such actions may be actions performed by or at the request of a computer device where the user profile is actively logged into the computer device. As another example, such actions may be actions performed by or at the request of a server system for a user profile that is currently logged into that server system via a client computer device. The connections of interconnected user profiles are direct or indirect connections between the user profiles in a computer system, which may include multiple sub-systems. For example, connections between interconnected groups of user profiles may include those user profiles existing within the same computer systems used by an organization which employs users represented by those profiles. Other looser computer system connections for user profiles of an organization may also exist. For example, the interconnected user profiles may be connected by data structures on computer systems not owned by the organization, such as on server systems that are providing computer services to the organization. As another example, an interconnected group of user profiles may be formed by social network connections (e.g., user profiles co-existing on a social network, or being “friends” on that network, or “following” or being “followed” by other user profiles on that network, or being included as members of a group on a social network, etc.) on a computerized social networking platform or network. There may also be other examples of such connections between user profiles.

In one aspect, the following indications of user profiles having an affinity for computer resources can be collected: indications of strength of connection between user profile pairs for an active user profile and another user profile; indications of strength of affinity between a user profile and a computer resource within each of multiple user profile-computer resource pairs; and indications of a global level of affinity of a global group of user profiles for computer resources. Using these indications, the following values can be generated: a connection strength value for each of the user profile pairs; an affinity strength value for each of the user profile-computer resource pairs; and a global affinity level value for each of the resources. These values can be used to rank the resources, which can include generating a ranked resource data structure to be used in providing resource recommendations.

In another aspect of the tools and techniques, usage of a computer resource by a plurality of computer-readable user profiles can be analyzed in a computer system to produce a plurality of indications of usage by the user profiles. Each of the indications can be connected in the computer system to an associated user profile that initiated the usage, and to the computer resource itself. A value representing usage of the computer resource by the plurality of computer-readable user profiles in an interconnected group of user profiles can be generated (where the user profiles are interconnected in data structures of the computer system), and a comparison of that value with a value for usage of the resource by another interconnected group of user profiles can be generated. The comparison can be returned in response to a computer-readable request.

This Summary is provided to introduce a selection of concepts in a simplified form. The concepts are further described below in the Detailed Description. This Summary is not intended to identify key features or essential features of the claimed subject matter, nor is it intended to be used to limit the scope of the claimed subject matter. Similarly, the invention is not limited to implementations that address the particular techniques, tools, environments, disadvantages, or advantages discussed in the Background, the Detailed Description, or the attached drawings.

### BRIEF DESCRIPTION OF THE DRAWINGS

FIG. 1 is a block diagram of a suitable computing environment in which one or more of the described aspects may be implemented.

FIG. 2 is a schematic diagram of a client-server computer ranking system.

FIG. 3 is another schematic diagram of a computer ranking system.

FIG. 4 is a diagram of a client device displaying a resource gallery display.

FIG. 5 is a flowchart of a computer resource ranking technique.

FIG. 6 is a flowchart of another computer resource ranking technique.

FIG. 7 is a flowchart of yet another computer resource ranking technique.

### DETAILED DESCRIPTION

Aspects described herein are directed to techniques and tools for improved ranking of computer resources based on computer-readable indications of computer-readable user profiles having an affinity for those resources (such as indications of usage of such resources by the corresponding user profiles). Such improvements may result from the use of various techniques and tools separately or in combination.

Such techniques and tools may include displaying a gallery populated with a list of computer resources, where the list of computer resources shown prominently in the gallery is influenced by the usage of resources by the user profiles closely connected to an active user profile. For example, the other user profiles may be profiles of co-workers of the user for the active user profile. In this respect, the ranking discussed herein can take into consideration not only usage at an organizational level, but also departmental computer resource usage and even virtual team computer resource usage, as well as usage on a global level that is not limited by association with a particular organization. The list of computer resources may be generated and displayed in response to a query, such as in a search and browse experience using the gallery of computer resources.

The computer system can also generate and display computer resource usage data and/or rankings, which can display to an administrator which computer resources are used across the organization, and to identify which solutions (i.e., computer resources that are useable by user profiles) should be used heavily but are not.

One or more substantial benefits can be realized from the computer resource ranking tools and techniques described herein. For example, employees who work in organizations can be encouraged by the computer system to use the same computer application or service as each other, so the employees can more effectively collaborate. For example, in an organization where application purchase decisions are not made by a centralized information technology department but are left up to each team, a sales team may want to use the same customer relationship management computer application—such a sales team could be at real disadvantage if every sales person were to start using and recording data in different customer relationship management systems. The use of the computerized ranking systems discussed herein can increase the efficiency of the computer system providing such suggestions, by avoiding multiple computer system searches that would be performed to eventually locate that same computer resources that can be automatically suggested with the techniques discussed herein. Additionally, the suggestions and rankings herein can make the computer system more useable for a wide variety of computer resources, thereby improving the computer system. By making such suggestions, use of advantageous computer resources can be encouraged, which can also avoid inefficient and/or incompatible use of the computer system with less advantageous computer resources.

Additionally, in some computer systems for organizations, software adoption/procurement happens at a departmental or organizational level. A finance solution may be very valuable to someone in a finance department, but much less so to someone in a dispatch department. Timeliness of recommendations is an aspect of this issue. If a new computer application (e.g., a floorplan creation application) becomes available in a public application store, it may take time for the application to become globally popular. However, if employees in a department virally adopt the application, it can be beneficial for all employees in that department to start adopting that application rapidly, so that the employees can gain the advantages of the application and avoid the computer inefficiencies of using different applications across the department. The computer resource ranking tools and techniques discussed herein can provide suggestions that can efficiently assist in such timely viral adoption, such as within a department of an organization where user profiles of the department employees would be connected together, as discussed herein.

For a new visitor to a given computer resource gallery, a generic application store recommendation system would typically be unable to provide personalized recommendations to that visitor because the application store computer system would have no history records of what the visitor previously searched for or used. However, using the tools and techniques herein, the computer system can rank computer resources for the user profile of such a new user by recognizing groups within which the new user's profile is interconnected. For example, the user profile may be connected to other user profiles within a database of user profiles for the organization, which can be organized into departments, divisions, teams, etc. Because much work in many organizations happens in virtual teams that are not represented in a database of managerial hierarchy, the ability to identify connections between user profiles based the computer-identified engagement between users, rather than based on pure managerial hierarchy, can result in more accurate and richer inputs to the ranking system for such organizations. Accordingly, the computer system can generate and display for the user profile a ranked list of add-ins used by user profiles connected to the new user profile in an organizational user profile database. Again, this can improve the computer system by avoiding inefficient use of a computer system to find computer resources that are useful for the new user profile, and also avoid inefficiencies that occur if the new user profile uses less-than-optimal computer resources for computer tasks being performed.

The computer resource ranking and usage tracking tools and techniques discussed herein can be applied to computer resources available in a publicly-available computer source such as a global application store. However, some or all of the techniques discussed herein may also apply to computer resources developed within an organization, such as templates, computer software application add-ins, etc.

Also, signals recorded about which computer solutions are most beneficial can also be provided to a computer system administrator. For example, the administrator may be responsible for procuring computer resources for an organization, and thus such an administrator may seek out data to prove the return on investment. The tools and techniques herein can be used to provide such information, such as information on usage by a particular department. Such information can include ranking information, such as the ranked data discussed herein, but such data may be combined to provide group-level usage data for computer resources. The computer system can also track which solutions have usability problems (i.e. used once but then not used again) or adoption problems (only used/discovered by pockets of the organization), and can provide such usage data to a rendering engine to be displayed on a computer display. For example, a display of such user data may reveal that a particular group of users should use a particular solution but they do not have rights access to the solution. Thus, the computer system can be improved by providing such data.

The subject matter defined in the appended claims is not necessarily limited to the benefits described herein. A particular implementation of the invention may provide all, some, or none of the benefits described herein. Although operations for the various techniques are described herein in a particular, sequential order for the sake of presentation, it should be understood that this manner of description encompasses rearrangements in the order of operations, unless a particular ordering is required. For example, operations described sequentially may in some cases be rearranged or performed concurrently. Moreover, for the sake of simplicity, flowcharts may not show the various ways in which particular techniques can be used in conjunction with other techniques.

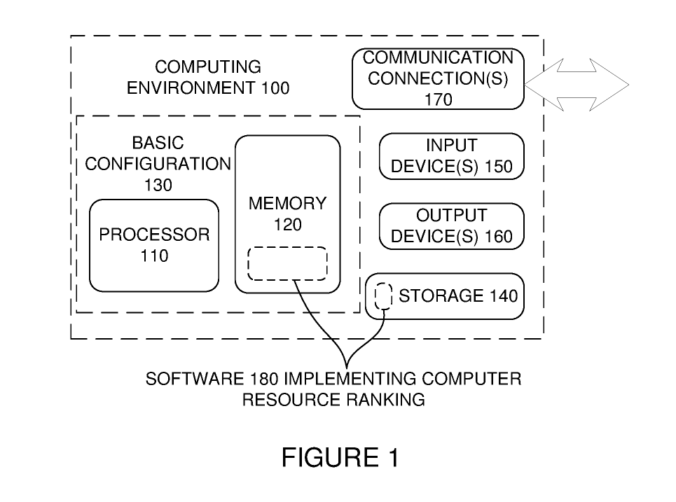

Techniques described herein may be used with one or more of the systems described herein and/or with one or more other systems. For example, the various procedures described herein may be implemented with hardware or software, or a combination of both. For example, the processor, memory, storage, output device(s), input device(s), and/or communication connections discussed below with reference to FIG. 1 can each be at least a portion of one or more hardware components. Dedicated hardware logic components can be constructed to implement at least a portion of one or more of the techniques described herein. For example and without limitation, such hardware logic components may include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc. Applications that may include the apparatus and systems of various aspects can broadly include a variety of electronic and computer systems. Techniques may be implemented using two or more specific interconnected hardware modules or devices with related control and data signals that can be communicated between and through the modules, or as portions of an application-specific integrated circuit. Additionally, the techniques described herein may be implemented by software programs executable by a computer system. As an example, implementations can include distributed processing, component/object distributed processing, and parallel processing. Moreover, virtual computer system processing can be constructed to implement one or more of the techniques or functionality, as described herein.

### I. Exemplary Computing Environment

FIG. 1 illustrates a generalized example of a suitable computing environment 100 in which one or more of the described aspects may be implemented. For example, one or more such computing environments can be used as a server computer device, client computer device, and/or stand-alone computer device. Generally, various different computing system configurations can be used. Examples of well-known computing system configurations that may be suitable for use with the tools and techniques described herein include, but are not limited to, server farms and server clusters, personal computers, server computers, smart phones, laptop devices, slate devices, game consoles, multiprocessor systems, microprocessor-based systems, programmable consumer electronics, network PCs, minicomputers, mainframe computers, distributed computing environments that include any of the above systems or devices, and the like.

The computing environment 100 is not intended to suggest any limitation as to scope of use or functionality of the invention, as the present invention may be implemented in diverse types of computing environments.

With reference to FIG. 1, various illustrated hardware-based computer components will be discussed. As will be discussed, these hardware components may store and/or execute software. The computing environment 100 includes at least one processing unit or processor 110 and memory 120. In FIG. 1, this most basic configuration 130 is included within a dashed line. The processing unit 110 executes computer-executable instructions and may be a real or a virtual processor. In a multi-processing system, multiple processing units execute computer-executable instructions to increase processing power. The memory 120 may be volatile memory (e.g., registers, cache, RAM), non-volatile memory (e.g., ROM, EEPROM, flash memory), or some combination of the two. The memory 120 stores software 180 implementing computer resource ranking as discussed herein. An implementation of computer resource ranking may involve all or part of the activities of the processor 110 and memory 120 being embodied in hardware logic as an alternative to or in addition to the software 180.

Although the various blocks of FIG. 1 are shown with lines for the sake of clarity, in reality, delineating various components is not so clear and, metaphorically, the lines of FIG. 1 and the other figures discussed below would more accurately be grey and blurred. For example, one may consider a presentation component such as a display device to be an I/O component (e.g., if the display device includes a touch screen). Also, processors have memory. The inventors hereof recognize that such is the nature of the art and reiterate that the diagram of FIG. 1 is merely illustrative of an exemplary computing device that can be used in connection with one or more aspects of the technology discussed herein. Distinction is not made between such categories as “workstation,” “server,” “laptop,” “handheld device,” etc., as all are contemplated within the scope of FIG. 1 and reference to “computer,” “computing environment,” or “computing device.”

A computing environment 100 may have additional features. In FIG. 1, the computing environment 100 includes storage 140, one or more input devices 150, one or more output devices 160, and one or more communication connections 170. An interconnection mechanism (not shown) such as a bus, controller, or network interconnects the components of the computing environment 100. Typically, operating system software (not shown) provides an operating environment for other software executing in the computing environment 100, and coordinates activities of the components of the computing environment 100.

The memory 120 can include storage 140 (though they are depicted separately in FIG. 1 for convenience), which may be removable or non-removable, and may include computer-readable storage media such as flash drives, magnetic disks, magnetic tapes or cassettes, CD-ROMs, CD-RWs, DVDs, which can be used to store information and which can be accessed within the computing environment 100. The storage 140 stores instructions for the software 180.

The input device(s) 150 may be one or more of various different input devices. For example, the input device(s) 150 may include a user device such as a mouse, keyboard, trackball, etc. The input device(s) 150 may implement one or more natural user interface techniques, such as speech recognition, touch and stylus recognition, recognition of gestures in contact with the input device(s) 150 and adjacent to the input device(s) 150, recognition of air gestures, head and eye tracking, voice and speech recognition, sensing user brain activity (e.g., using EEG and related methods), and machine intelligence (e.g., using machine intelligence to understand user intentions and goals). As other examples, the input device(s) 150 may include a scanning device; a network adapter; a CD/DVD reader; or another device that provides input to the computing environment 100. The output device(s) 160 may be a display, printer, speaker, CD/DVD-writer, network adapter, or another device that provides output from the computing environment 100. The input device(s) 150 and output device(s) 160 may be incorporated in a single system or device, such as a touch screen or a virtual reality system.

The communication connection(s) 170 enable communication over a communication medium to another computing entity. Additionally, functionality of the components of the computing environment 100 may be implemented in a single computing machine or in multiple computing machines that are able to communicate over communication connections. Thus, the computing environment 100 may operate in a networked environment using logical connections to one or more remote computing devices, such as a handheld computing device, a personal computer, a server, a router, a network PC, a peer device or another common network node. The communication medium conveys information such as data or computer-executable instructions or requests in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The tools and techniques can be described in the general context of computer-readable media, which may be storage media or communication media. Computer-readable storage media are any available storage media that can be accessed within a computing environment, but the term computer-readable storage media does not refer to propagated signals per se. By way of example, and not limitation, with the computing environment 100, computer-readable storage media include memory 120, storage 140, and combinations of the above.

The tools and techniques can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various aspects. Computer-executable instructions for program modules may be executed within a local or distributed computing environment. In a distributed computing environment, program modules may be located in both local and remote computer storage media.

For the sake of presentation, the detailed description uses terms like “determine,” “choose,” “rank,” “adjust,” and “generate” to describe computer operations in a computing environment. These and other similar terms are high-level abstractions for operations performed by a computer, and should not be confused with acts performed by a human being, unless performance of an act by a human being (such as a “user”) is explicitly noted. The actual computer operations corresponding to these terms vary depending on the implementation.

### II. Computer Resource Ranking System

A. Computer Resource Ranking Overview

A computer system for ranking computer resources as discussed herein can include three subsystems (though it may include a subset of these subsystems, and may include additional subsystems). First, the ranking system can include a system to identify and record the strength of relationship between a given individual and all the other members of his/her organization, including a notion of temporality as organizational relationships change over time (e.g., older indications can be weighted less than newer ones, and some older indications may be disregarded altogether if they are older than a predetermined amount of time). This can be performed by generating connection strength values between different user profiles for the organization in a computer system.

Second, the ranking system can include a system to identify and record the strength of interest or affinity between a given individual and all the computer solutions, i.e., computer resources, that individual interacts with. This affinity may be positive (such as active usage) or negative (such as uninstallation of the resource, or the user profile left a user review below a threshold value, such as a one or two star review out of five stars). This recording of affinity values can be performed by recording each particular interaction between a user and a computer resource or a particular interaction between a user with one user profile and a user with another user profile. These atomic interactions may include a time/date stamp and they may be aggregated to allow for the generation of an affinity strength value between the user profile and the respective computer resource with which the user profile interacts. Generation of an affinity strength value may include applying a decay operation, which can apply decay values to older values so that more recent interactions more strongly influence the resulting ranking.

Third, the ranking system can include a system to identify and record the global level of interest or affinity for a given resource, across multiple organizations, such as across all organizations available in a system. This can be performed by aggregating all available user profile interaction scores for each resource to be ranked, to generate a global affinity value for each such resource.

Data from these three subsystems can be combined to form a single relevance-sorted list of solutions, with results influenced by what a user's co-workers use, by personalizing the list to the user's user profile (the active user profile) and considering other user profiles of the co-workers, which are interconnected with the active user profile.

B. Simplified Ranking Example

Following is a simplified example of how the data from the three subsystems noted above can be combined to produce a sorted list, which may populate a resource gallery display on a computer device. While this example is presented with a simplified formula to explain the concepts, the concepts herein can be used in more complex techniques and/or formulae that can include weighting of factors, applying additional operations (producing logarithms of particular values, normalizing scores to a range, etc.). Such weighting and applying of other operations can be performed by computer systems and modified by persons skilled in the art to account for features of specific systems, specific inventories of computer resources, prevalent sizes of interconnected user profile groups being analyzed, etc. For example, a particular technique with particular weightings may be applied to a set of test data to refine the system prior to use, and the system may continue to be refined using feedback, such as using feedback data from user responses to the presentation of the results of the ranking. For example, the system may be refined based on which computer resources users select from a list of presented resources, which resources are used more (and used how much over a period of time) from among a list of resources, etc. Such feedback refining techniques are known in computer search engine technology. Following are steps in this simplified ranking example.

STEP 1: Given a user profile for a user Bob, create a 1 to N sorted list of user profiles for Bob's coworkers and the current strength of their connection to Bob's user profile (such as the number of emails they exchange, the number of phone calls or texts they exchange, the number of documents they coauthor or review, the number of internal sites that they are both a member of, the number of meetings they jointly attend, the closeness of their hierarchical managerial relationship, etc.). Following are some example values: Bob→Joe (i.e., the connection strength between Bob and Joe's user profiles): (0.8); Bob→Mary: 0.6; and Bob→Ian: 0.02. Optionally, to simplify the analysis and possibly to improve results, coworkers whose user profiles have a connection strength with Bob's user profile that are below a predetermined threshold may be excluded. For example, consider a threshold of 0.05. With that threshold in the example above, the user profile “Ian” is excluded from further consideration, so that the Ian user profile's affinity for computer resources is not considered in the ranking.

STEP 2: Given the top co-workers (e.g., a predetermined number of user profiles with the highest connection strengths to Bob's user profile, such as the top one hundred user profiles), a list of all computer resources in a set of suggestable (e.g., those to which the current user has access) resources that those user profiles have recently used along with the depth of usage of each solution by that co-worker's user profile (such as the number of times actions have been performed with the resource, the amount of time spent using that resource, the number of positive reviews for the resources, with values being decreased by negative indications such as negative reviews or uninstallations) can be generated. This list generation can include generating affinity strength values for each such user profile-computer resource pair from the usage data. As was the case for user profiles, the actual generation of affinity strength values may be based on the aggregation of particular interactions recorded with date/time stamps, and applying operations to those recordings, such as incorporating a decaying factor such that more recent interactions influence ranking to a greater extent. Following are some example values: Joe→Solution 1 (the affinity strength value between Joe's user profile and computer resource titled Solution 1): 0.9; Joe→Solution 2: 0.4; Joe→Solution 3: 0.2; Mary→Solution 1: 0.9; Mary→Solution 4: 0.1; Mary→Solution 3: 0.02. These solutions can include computer resources of different types. For example, Solution 1 may be a remote computer service, Solution 2 may be an application that is available for downloading, and Solutions 3 and 4 may be a document templates (e.g., one spreadsheet template and one word processing template). Optionally, to decrease the computational time and resources needed to complete the analysis and possibly to improve results, computer resources whose affinity strength with the corresponding coworker's user profile are below a predetermined threshold may be excluded. For example, consider a threshold of 0.2. With that threshold in the example above, the Mary→Solution 2 pair is excluded from further consideration, so that affinity of the Mary user profile for the Solution 2 computer resource is not considered in the ranking. Note that negative values for the affinity may also be present and may be used in the analysis to decrease the ranking of a corresponding computer resource. For example, a negative value may result from a user profile giving a computer resource a negative review, or from uninstalling a resource.

STEP 3: Where the data exists, affinity of the active user profile (Bob, in this example) in each identified computer resource can be considered. The resulting score may quantify pre-existing usage by the Bob user profile, and/or may identify that the Bob user profile has been recommended a given solution repeatedly yet always ignores it. Following are some example values for the Bob user profile: Bob→Solution 3 (Bob user profile's affinity for the Solution 3 computer resource, with a negative value indicating a negative affinity, which can decrease the ranking of the Solution 3 computer resource): −2; Bob→Solution 4: 0.9. Again, values that are below a predetermined threshold (or above a threshold for negative values) may be excluded from the analysis.

STEP 4: The scores discussed above can be merged with each other, and possibly with additional factors, such that a final per-resource score can be created, considering the affinity of the Bob user profile and the affinity of interconnected user profiles for the resources. Note that the actual scoring formula is simplified here for the purpose of this high level explanation. Following are examples of the simplified scoring computations:
Solution 1=Joe (0.9*0.8)+Mary (0.9*0.6)=rank of 1.26
Solution 2=Joe (0.4*0.8)=rank of 0.32
Solution 3=Joe (0.2*0.8)+Bob (−2)=rank of −1.84
Solution 4=already used by Bob
   Note that Solution 4 can optionally be excluded because it is already used by Bob's user profile.

STEP 5: Global affinity scores for the computer resources can be generated and/or retrieved. Such global affinity scores can include factors such as a validation rating by reviewers, a user review rating, a global usage rating based on a data regarding how much the computer resource is used, and global download score based on how many times the computer resource has been downloaded. If the user profile issued a search query or is browsing, the details from the browsing session and/or search query can be used to alter the scores for the resources. For example, if a particular search query (such as a query using the term “CRM”) results in a particular resource being selected by user input across many organizations globally, this fact may be used as a factor to improve resource ranking. The technology field of information retrieval has many additional approaches to improve ordering of search results (at a global level as well as within organizations)—such approaches may complement the interconnected user profile resource ranking tools and techniques described herein. Optionally, resources already used by Bob's user profile may be excluded. Following are some example global affinity scores: Solution 1: 0.3; Solution 2: 0.8; Solution 3: 0.9; Solution 4: 0.9 (already used by Bob); Solution 5: 0.6.

STEP 6: The personalized ratings scores can be blended with the global affinity values. Following is a simplified example of such blending:
Solution 1=0.3+1.26=total of 1.56
Solution 2=0.8+0.32=total of 1.12
Solution 3=0.9+−1.84=total of −0.94
Solution 5=0.6

In this simplified example, even though Solutions 2, 3 and 5 had higher global popularity than Solution 1, the fact that Bob's co-worker user profiles heavily leveraged Solution 1 resulted in Solution 1 being highest in the rankings. In generating the final score for each solution, other scores may also be blended with the personalized ratings scores and the global affinity values. Thus, the techniques discussed herein can be used to complement other computerized information retrieval techniques. For example, contextual global information retrieval ranking techniques may be used to produce scores that can be used as factors along with the personalized ratings scores and the global affinity values. For example, a record may be kept that indicates user profiles who submit a particular original query such as “accounting”, and later navigate to a particular page such as a category browse page for customer relationship management applications tend to select different applications than those who submitted an original query for “contacts”. Thus, some applications may receive higher scores when the original query was “accounting” while other application may receive higher scores when the original query was “contacts”. As another example, while a given contact management application that appears both in a Customer Relationship Management category and an Employees category might be globally popular, the application may be selected much more in the Customer Relationship Management category than the Employees category. Thus, the contact management application may be given a higher score when it appears in the Customer Relationship Management category than the Employees category. As yet another example, at a global level, users who have previously acquired Solution 1 may be more likely to use Solutions 3 and 4. Thus scores for Solutions 3 and 4 may be boosted for a user of Solution 1. All, none, or some of these particular factors may be incorporated into the final score, possibly along with other factors, depending on the particular implementation.

STEP 7: The results can be presented by the computer system, such as by being displayed on a computer display screen. Following is a non-exhaustive list of a few examples for how the results may be displayed:
Option 1: Show a 1 to N list of all solutions, ordered by the total rank (which is influenced by personalized group usage and by global usage, and may also be influenced by other factors). This can be done on a homepage, or in a category browsing context, or after the user types a search query.
Option 2: Use the personalized rank or the total rank to show as one of a set of filmstrips on a homepage (e.g., filmstrips with titles such as “New and Noteworthy,” “Editor's picks,” or “Get the Solutions Your Co-Workers Are Using”).
Option 3: Identify whether a set of resources exceed a certain threshold, and for those resources whose ranking scores exceed the threshold, use a more proactive notification system such as showing in-application notifications to encourage the user to use such resources.

The user interface presentation may show a title for each computer resource represented in the display, and the user interface presentation may also show the count and/or names of the active user's co-workers whose user profiles are using the highlighted computer resources.

C. Computer System Architecture Examples

1. Client-Server Computer Resource Ranking System

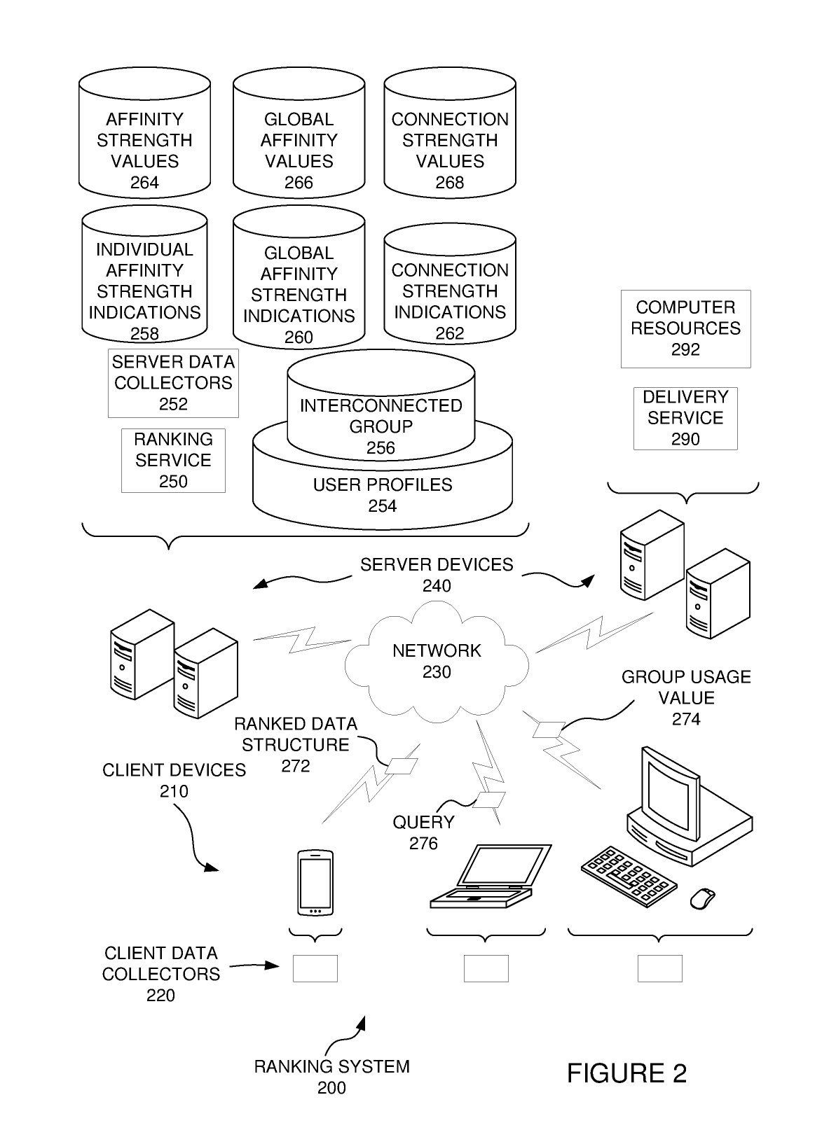

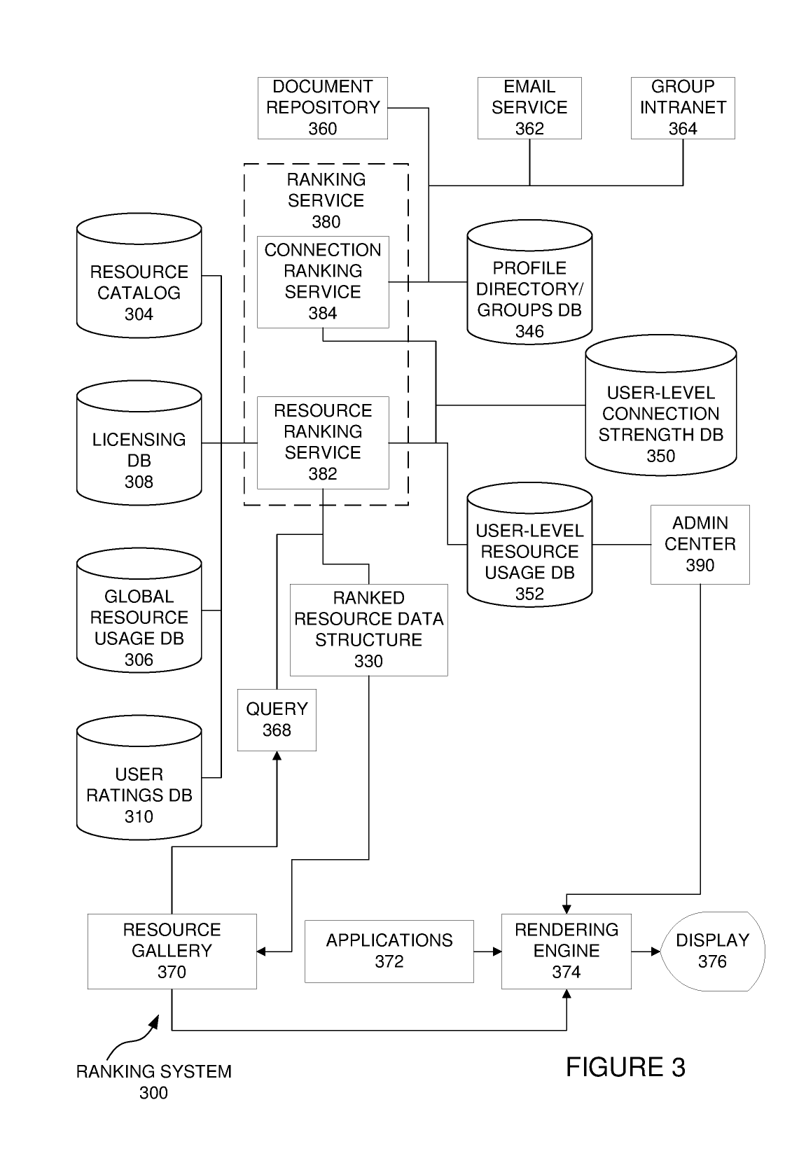

FIG. 2 is a block diagram of a computer resource ranking system 200 in conjunction with which one or more of the described aspects may be implemented. The ranking system 200 will be described in general terms but with reference to a client-server system, and another ranking system will be discussed below with reference to FIG. 3. The discussion of the ranking system of FIG. 3 will not be discussed in specific client-server terms, but will include additional details as to some example components and examples of details of ranking techniques. Nevertheless, it should be appreciated that the components discussed herein with reference to FIG. 2 may be rearranged so that components discussed with reference to server or client devices may be rearranged, and the components may be implemented in some different arrangement, such as where all the components are implemented in a stand-alone system or in a peer-to-peer computer network.

Communications between the various devices and components discussed with reference to FIG. 3 and elsewhere in this application can be sent using computer system hardware, such as hardware within a single computing device, hardware in multiple computing devices, and/or computer network hardware. A communication or data item may be considered to be sent to a destination by a component if that component passes the communication or data item to the system in a manner that directs the system to route the item or communication to the destination, such as by including an appropriate identifier or address associated with the destination. Also, a data item may be sent in multiple ways, such as by directly sending the item or by sending a notification that includes an address or pointer for use by the receiver to access the data item. In addition, multiple requests may be sent by sending a single request that requests performance of multiple tasks.

Referring still to FIG. 2, components of the ranking system 200 will be discussed. Each of the components of FIG. 2 and FIG. 3 includes hardware, and may also include software. For example, a component of FIG. 2 or FIG. 3 can be implemented entirely in computer hardware, such as in a system on a chip configuration. Alternatively, a component can be implemented in computer hardware that is configured according to computer software and running the computer software. The components can be distributed across computing machines or grouped into a single computing machine in various different ways. For example, a single component may be distributed across multiple different computing machines (e.g., with some of the operations of the component being performed on one or more client computing devices and other operations of the component being performed on one or more machines of a service).

The computer resource ranking system 200 can include client computer devices 210, such as smartphones, tablet computers, laptop computers, desktop computers, hybrid computer devices, or other computer devices such as wearable computer devices. The client computer devices 210 can include client data collectors 220, which can operate to collect data, such as computer resource affinity strength indication data and/or user profile connection strength indication data. The client devices 210 can be connected to the network 230, such as through wired and/or wireless connections, and can send collected data to server devices 240 over the network 230.

The server devices 240 can be connected to the network 230, so that the server devices 240 can communicate with each other and/or with the client devices 210 via the network 230, which may be a single network or multiple interconnected wired and/or wireless networks. The server devices 240 can include a ranking service 250, which can provide personalized rankings of computer resources. The server devices 240 can also include server data collectors 252, which can collect data similar to the types of data collected by the client data collectors 220. The server data collectors 252 and client data collectors 220 can each collect different types of data and/or data in different scenarios. For example, the client data collectors 220 may collect usage data for the use of computer resources more closely associated with the client devices 210 (e.g., data representing usage of applications or documents stored on the client devices 210), where such resources may be used without interaction with the server devices 240. Similarly, the server data collectors 220 may collect usage data representing the use of computer resources more closely associated with the server devices 240 (e.g., data representing usage of applications or documents that are primarily stored on the server devices 240, such as Web-based applications or documents stored in cloud storage services).

The server devices 240 can also store user profiles 254, which may be accessed by the ranking service 250. Such user profiles 254 may include user profiles for multiple interconnected groups 256, such as groups of user profiles that are each connected to each other and/or to an organization in a stored data structure. For example, such an organization may be a business entity or other organization, a department or division within a business entity, or a grouped team. Thus, there may be multiple levels of interconnected groups 256, some of which can be sub-groups of larger groups. For example, there may be an interconnected group 256 of user profiles 254 for a business entity, and multiple sub-groups for the business entity, such as an interconnected group 256 for a finance department of the business entity, and another interconnected group 256 for a marketing department of the business entity. On the other hand, the user profiles 254 can be all available user profiles, and may include user profiles from multiple different organizations, including the organization corresponding to the interconnected group 256 and other organizations. In one example, the user profiles 254 may be user profiles on a public online application store, and the linked group 256 may be user profiles for employees of a business entity, where the user profiles in the linked group 256 are also user profiles for the application store. The connections between user profiles 254 may take any of various forms, such as by including stored data that references user profiles 254 in an interconnected group 256, or where the user profiles 254 themselves include references to other user profiles 254. Or as another example, user profiles 254 may be considered part of a group by their placement in a certain area of a stored data structure.

Referring still to FIG. 2, the server devices 240 can also include stored individual affinity strength indications 258, which may be accessed and used by the ranking service 250, and which may be provided by the client data collectors 220 and/or the server data collectors 252. The individual affinity strength indications 258 can be data that indicates (directly or indirectly) strength of affinity of an individual user profile 254 for a particular computer resource (possibly when aggregated with other indications indicates). Thus, the individual affinity strength indications 258 can be analyzed to compute affinity strength values that represent the affinity of an individual user profile 254 for a particular computer resource. Each individual affinity strength indication 258 may be a positive indication, indicating an affinity of the user profile 254 for the computer resource. As an example, such an indication may be a positive indication, such as indicating that the user profile 254 has used the computer resource. Or the indication may be a negative indication, such as indicating that a user profile gained access to a computer resource (e.g., installed an application), but has not used it, or that the user profile 254 gave the computer resource a negative review. In one example, the individual affinity strength indications 258 may be utilized by the ranking service 250 to rank computer resources for other user profiles 254 in the same interconnected group 256 (e.g., the same organization, and/or in the same division of an organization) as an active user profile 254 for which the ranking is being performed. In a further example, it may be that there is some collaboration between two or more organizations (such as a joint project or a company merger), and thus the user profiles considered and analyzed may come from a defined set of multiple organizations.

In addition to the individual affinity strength indications 258, the server devices 240 may include global affinity strength indications 260. Such global affinity strength indications 260 may indicate positive or negative affinity for computer resources similarly to the individual affinity strength indications 258 discussed above. However, the global affinity strength indications 260 can include indications from user profiles 254 from outside the interconnected group 256 of the active user profile 254 for which resources are being ranked (and may or may not include resources from within the interconnected group 256 of the active user profile 254). The global affinity strength indications 260 may be anonymized, so that each such global affinity strength indication 260 does not refer to a specific user profile 254, as do the individual affinity strength indications 258.

The server devices 240 can further include connection strength indications 262, which can be used by the ranking service 250. The connection strength indications 262 can indicate strength of connection between pairs of user profiles 254. For example, such indications can be based on data from usage of computer resources by the paired user profiles 254, or from the locations of the user profiles 254 in a business employee directory data structure, or from similarity of job titles for the user profiles 254, etc. Such indications can be considered by the ranking service 250 in ranking computer resources where one of the connected user profiles 254 is the active user profile 254 for which resources are being ranked.

The ranking service 250 can utilize the indications 258, 260, and 262 to generate values that can be used in ranking computer resources for a user profile 254 or group of user profiles 256. The ranking service 250 can use the individual affinity strength indications 258 to generate affinity strength values 264, which can each represent the affinity of an individual user profile 254 for a computer resource. The ranking service 250 can also use the global affinity strength indications 260 to generate global affinity values 266, which can each represent a level of affinity of user profiles 254 for corresponding resources. The global affinity values 266 can include values for user profiles 254 outside of an interconnected group 256 that includes an active user profile 254 for which computer resources are being ranked. For example, global affinity values 266 may each represent an affinity that is not restricted by organization or groups of the user profiles 254 that produced the actions being quantified by the values. Accordingly, each global affinity value 266 can represent user profiles' affinity for a resource without regard to the groups to which the user profiles belong, so that each such global affinity value 266 may represent an affinity strength of user profiles for a resource across all available groups, or possibly all groups except the interconnected group 256 to which the active user profile 254 belongs (because the affinity of that group may already be considered at least to some extent in the affinity strength values 264).

Also, the ranking service 250 can use the connection strength indications 262 to generate connection strength values 268 that represent the strength of connection between user profiles 254 in pairs of user profiles 254 or interconnected groups 256 (such as between two user profiles 254, between a user profile 254 and an interconnected group 256, and/or between two interconnected groups 256).

The ranking service 250 can use the affinity strength values 264, the global affinity values 266, and the connection strength values 268 to produce a ranked data structure 272 that represents the ranking of computer resources for a particular user profile 254 or interconnected group 256. The ranking service 250 can send the ranked data structure 272 to a client device 210 over the computer network 230. The ranking service 250 can also use the affinity strength values 264, the individual affinity strength indications 258, and/or other measures of computer resource usage (such as the average number of times that a particular template is used by a user profile in the group in a 30-day period) to produce a group usage value 274 for a group. The group usage value 274 can represent usage of computer resources by an interconnected group 256, such as a sub-group of a larger group, which is in turn part of the global set of user profiles 254. In just one example, a group usage value 274 can quantify usage of a computer resource by user profiles in a particular division of a business entity. The group usage value 274 can be sent by the ranking service 250 or a separate service that produces the group usage value 274 to a client device 210. For example, the client device 210 receiving the group usage value 274 may be a device that is computer resource usage information for an administrator center, and the group usage value 274 may be used in the administrator center, as discussed below. The ranked data structure 272 and/or group usage value 274 can be generated and returned in response to a request such as a query 276 sent from an administrator user profile's client device 210 to the ranking service 250. The ranking service 250 can consider the terms of the request, such as query search terms, in generating the ranked list, and may also include other factors as well, according to known searching techniques.

The server devices 240 may also include a delivery service 290, which can deliver access to the computer resources 292. For example, the delivery service 290 may send software resources such as applications, documents (e.g., word processing documents, spreadsheets, digital presentations, image files, Web pages, etc.), sound files, or video files to a client device 210.

While the system of FIG. 2 is described in the context of a client-server system, the components discussed therein can be used with other computer system structures, such as within a peer-to-peer network, or within a single stand-alone computer device.

2. Example Architecture for Different Types of Computer System Structures

As noted above, multiple intertwined computer services may be utilized to perform the ranking techniques discussed herein. With reference to FIG. 3, some of those services will be discussed, without regard to the type of computer system structure, so that it is abundantly clear that the tools and techniques discussed herein can readily apply to a stand-alone computer device, a peer-to-peer computer network system, and/or a client-server network system, as just a few examples.

There are a number of known computer sub-systems depicted for the ranking system 300 of FIG. 3. For example, a global computer resource provider, such as an on-line computer resource store (such as an application store), can provide a resource catalog 304 of computer resources, which could be applications, templates, software add-ins for applications, or other computer resources. The resource catalog 304 may include the resources themselves and/or references to the resources. These resources can be provided first-party, by an entity that is managing the computer resource store, and/or by a third-party that submits the resources to the computer resource store but does not manage the store. The computer resource store can record which users download, browse, use, and/or buy solutions in a global solutions usage telemetry database 306. The ranking system 300 may include further systems to record data for computing additional factors, such as context-specific ranking factors, factors representing which resources are commonly used together, etc. Licenses (e.g., licenses provided when a user profile buys or signs up for a solution from the resource store), can be saved in a secure licensing database 308. User ratings or reviews of user profiles for computer resources can be saved in a user ratings database 310, which may or may not be part of the computer resource store.

The ranking system 300 can create a single ranked resource data structure 330 of computer resources from the resource catalog 304 by configuring the resulting ranked resource data structure 330 to point to the catalog 304. The creation of references in the ranked resource data structure 330 may be as simple as providing a pointer to the location of the catalog 304 for each listed resource, and providing a unique identifier that corresponds to a unique identifier for the computer resource in the catalog 304. For example, the unique identifier may be an application identifier or a uniform resource locator pointing to the computer resource.

Other inputs recorded within the ranking system 300 are provided by various services. For example, productivity services may include services such as a document repository 360, an email service 362, a group intranet service 364, and/or a user profile directory/groups database 346 (such as an employee directory that references or includes user profiles for the employees). Indications of resource usage can be retrieved from such services and recorded. The user profile directory/groups database 346 can provide information on whether a user profile is for an individual in the same organization as other individuals, and may provide a unique identifier for each such user profile. The services, such as the document repository 360, the email service 362, and the group intranet service 364 can enrich the quantity and quality of data to establish the existence and strength of connection between different user profiles. For example, if Bob's user profile sends an email to Mary's user profile, or if Bob's user profile authors a document that Mary's user profile co-authors, there is a connection between Bob and Mary's user profiles that goes beyond their existence in the same general group or organization. Thus, monitoring of such interactions can establish a more precise measure of connection strength between user profiles.

The connection indications that are detected in the group data, such as in the document repository 360, the email service 362, the group intranet service 364, and/or the user profile directory/groups database 346 can be logged into a user-level connection strength database 350. An operation can be run on that data to compute an individual's interrelatedness to others as a numeric score (i.e., a strength of connection value), as discussed in more detail below.

A user-level resource usage database 352 can record which users use a particular solution, when and how intensely, using data from services such as the document repository 360, the email service 362, the group intranet service 364, an application store, and/or the resource catalog 304.

A resource gallery 370 (which may or may not be directly integrated into applications 372) can provide listings of one or more available computer resources from the ranked resource data structure 330 to a rendering engine 374 for display on a computer display 376 or other output device, such as computer speakers, etc. For example, the resource gallery 370 can identify which user is accessing the resource gallery 370, such as by identifying an active user profile that is currently logged into a corresponding device or software application or service with appropriate credentials (username, password, etc.), when a request is made to the resource gallery 370.

The resource gallery 370 can send a query 368 to a ranking service 380, and particularly to a resource ranking service 382 (whether or not a textual query was requested by user input). The resource ranking service 382 can query the resource catalog 304 for resources that match terms of the query 368. For example, if the solutions gallery 370 is a template gallery, the resource ranking service 382 can search the catalog 304 for available computer resources, which are templates and which the active user profile has rights to access. Either as part of querying the catalog 304 or as separate queries, the resource ranking service 382 can retrieve relevant indications of affinity strength for each computer resource, which can inform resource ranking. Additionally, the resource ranking service 382 can invoke the connection ranking service 384 to access the user-level connection strength database 350, and return connection strength values for user profiles connected to the active user profile. The resource ranking service 382 can use this data to rank available computer resources in a manner personalized to the user profile, as discussed herein.

The resource ranking service 382 can populate a ranked resource data structure 330, which can rank the computer resources according to the ranking performed by the resource ranking service 382. The resource ranking service 382 can respond to the query 368 by sending the ranked resource data structure 330 to the resource gallery 370. For example, the ranked resource data structure 330 may be a simple text list sorted according to each resource's final ranking score assigned by the ranking service 380, such as a list in a format such as XML, HTML, and/or some other format recognizable to the resource gallery 370. As an alternative to having a list sorted in ranking order, the ranked data structure 350 may include a data record for each resource, and each record can indicate the final rank or ranking score from the ranking service 380 for the corresponding resource. The ranked resource data structure 330 can include information such as location information (such as links and/or address information) for the computer resources in the catalog 304, a title for each computer resource, a description of affinity strength for one or more of the computer resources (e.g., “Mary and 25 other colleagues in your Finance department use this template”), and/or other information.

As with other components depicted in the figures and discussed herein, the ranked resource data structure 330 may be a continuous component (a continuous structure in memory) or may be split into multiple discontinuous but connected portions (such as multiple files, multiple database tables, etc.). The listing of computer resources in the ranked resource data structure 330 can be sorted according to the rankings generated by the resource ranking service 382 (such as by including indications of rank in the ranked resource data structure 330 and/or listing the resources in order of rank in the ranked resource data structure 330).

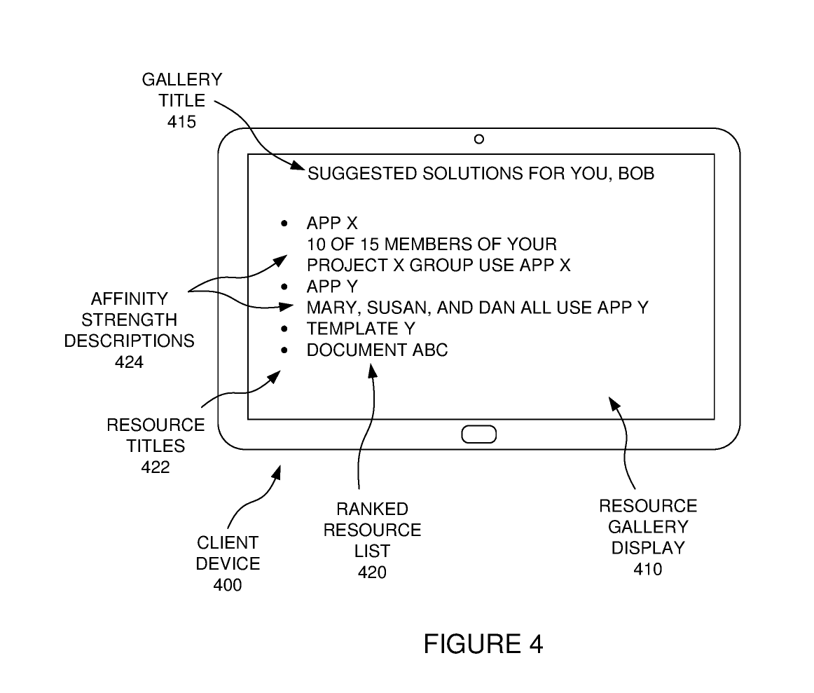

Referring now to FIG. 4, an example of a client device 400 displaying a resource gallery display 410 on a computer display screen of the client device 400 is illustrated in simplified form. The resource gallery 410 can include an overall gallery title 415 for the resource gallery display 410. Additionally, the resource gallery display 410 can include a ranked resource list 420, which can include a resource title 422 for each resource in the list. The resource titles 422 (e.g., “APP X”, “APP Y”, TEMPLATE Y”, “DOCUMENT ABC”) can be listed in order of their respective ranking scores. Additionally, one or more of the resource titles 422 can be accompanied by an affinity strength description 424 (e.g., “10 of 15 members of your project x group use APP X”, or “Mary, Susan, and Dan all use APP Y”).

3. Administrator Center

Referring back to FIG. 3, the ranking system 300 can further include an administrator center 390, which can display a list of solutions in use across an organization. For example, the list of solutions may be a list of computer resources used by user profiles in an interconnected group that represents the users of an organization. The administrator center 390 can send the list to the rendering engine 374 for display on the computer display 376. Of course, as with the other components in FIG. 3, the administrator center 390 may interact with different rendering engines and different displays on different devices in the ranking system 300. The administrator center 390 may filter such a listing in useful ways. For example, the administrative center may provide a ranked listing of computer resources used by computer profiles in a particular interconnected group—such as a given department or virtual group in an organization—and may provide values that represent group usage for each such computer resource. Such usage values may also be limited to usage by user profiles in a particular interconnected group, which may be a sub-group of an interconnected group for the entire organization. For example, the administration center may query the user-level resource usage database 352 for such usage data, and may generate or retrieve values representing indications of usage by the interconnected group.

The administrator center 390 may provide an administrator with a list of aggregate ranked recommendations for a group of users. For example, this can include combining (e.g., summing or some other operation) the resource ranking scores for all user profiles in a group of user profiles, which may be a sub-group of user profiles. The administrator center 390 can retrieve such scores from the resource ranking service 382 directly, or through the resource ranking service 382 storing such resource ranking scores in the user-level resource usage database 352, and the administrator center 390 retrieving the scores from the user-level resource usage database 352. For example, in an organization where computer resources are made available by administrators, such an administrator in one department may be able to see that a particular computer resource is used extensively in other departments, so that the administrator can make the resource available and possibly suggest the use of the resource in his/her department as well. For example, the administrator's user profile may deploy the computer resource to computers for other user profiles in the department.

As another example of operation of the administrator center 390, where an administrator's user profile has assigned licenses or usage rights for a given computer resource to user profiles in group G, the administrator center 390 can query the user-level resource usage database 352 to retrieve usage strength values or usage strength indications (from which the administrator center can calculate usage strength values) for the licensed resource by user profiles in group G. The administrator center 390 can combine the values for the users (such as by summing the values or some other operation) to generate a usage value for the resource for all of group G. The administrator center 390 may also query the user-level resource usage database 352 for a listing of which particular user profiles are using the resource, and a value representing the strength of that usage (such as a value summing all instances of the usages, possibly with weights being applied to at least some types of usage instances). A listing of such values can be sent from the administrator center 390 to the rendering engine 374 for display on the display 376.

The administrator center 390 may also provide other types of queries of the usage data, such as querying the user-level resource usage database 352 for a listing of the types of usage being made of a computer resource (e.g., whether a word processing application being used primarily to view files, or whether it is being used primarily to author and edit files). Accordingly, the administrator center 390 can improve the ranking system 300 by providing the ability for an administrator's user profile to investigate details if adoption of a purchased computer resource is less than desired, and/or if a computer resource should be eliminated (or at least some licenses should be eliminated) due to lack of use, and/or if additional licenses should be purchased.

As yet another example of operation of the administrator center 390, where a computer resource is virally used, the administrator center 390 may generate and display a value for the usage strength for the computer resource across the entire organization. For example, the administrator center may provide a data structure indicating 70 heavy users of the computer resource and 32 light users of the computer resource, and may send that data structure for display. The administrator center 390 may provide further processing using known techniques to determine which sub-groups in the organization use the computer resource the most, and to provide a description of such usage. For example, the administrative center 390 may query the user-level resource usage database 352 to determine that 82% of the Finance team uses the computer resource, and a data structure indicating such usage descriptions can be sent from the administrator center 390 to the rendering engine 374 for display on the computer display 376. (As with other display acts discussed herein, the data may also be presented in other ways with the computer system, such as by using text-to-speech techniques to audibly read the information using computer speakers.) Moreover, the administrator center 390 may provide a comparison of values representing usage of a resource by different groups. For example, such a comparison may reveal that one sub-group of the company is actively using a particular resource, but the resource is not being adequately used by another group of the company that would have similar needs for the resource. As an example, such a comparison may include generating a group ranking score for two different groups, by summing the ranking scores for the resource the profiles in each group to produce a group ranking score. A description of the comparison may be a simple data structure listing both group ranking scores for the respective groups, or it may be more involved. For example, the comparison may be generated by performing a differencing function on the ranking scores to reveal the difference in the amount or type of usage between different groups, and those differences may be described in a data structure that is sent. As another example, the comparison may be illustrated with a data structure that provides a table or chart to depict the comparison between the ranking scores of the different groups, and the generating of the comparison may include generating such charts or tables.

Such usage information can improve the ranking system 300 by providing useful information on group usage, such as by proving that money spent on the computer resources in the computer systems was worthwhile. Such information can be provided in an efficient manner using monitored usage indications, and processing those indications to generate values representing usage across different interconnected groups of user profiles.

D. Additional Ranking Details

General ranking techniques are discussed above. This section will discuss particular types of data that may be monitored and included in the ranking techniques. The ranking details will be provided with reference to the steps discussed above in the Simplified Ranking Example section. These details and others discussed in the Simplified Ranking Example section and elsewhere may be performed at runtime in response to a query, but at least some of the details and values may be pre-computed to decrease the response time in responding to a query with a ranked resource data structure 330 and/or a response from the administrator center 390. Following is a description of some additional details of the techniques involved in the ranking steps.

1. Step 1 from Simplified Ranking Example Above: Identifying Strength of Relationship

As discussed above, user-level resource usage database 352 can be created and maintained with a list of user to user interactions (a.k.a. signals, or connection strength indications 262) and timestamps for the interactions. Each different type of signal may also have a different weight associated with it for calculating the connection strength values 268. Thus, as an example, in calculating a connection strength value 268 for a pair of user profiles, for each type of interaction, the computer system can multiply the number of interactions of that type between the pair of user profiles by the weight for that type of interaction to produce an interaction type score for the pair of user profiles. Then, as an example, the computer system may sum all the interaction type scores for the pair of user profiles to produce a connection strength value 268 between the user profiles.

The different types of interactions may include higher frequency but temporary interactions (e.g., sending an email), and they may also include more static interactions (e.g., one user profile is listed as a supervisor for another user profile). Following are some examples of some temporary interactions (using “Bob” and “Mary” as an example of a pair of user profiles):
Bob sends an email to Mary who is on the to: line (or vice versa, i.e., Mary sends Bob an email);
Bob sends an email to Mary who is Cc'd (or vice versa);
Bob instant messages Mary (or vice versa);
Bob sends a text message to Mary (or vice versa);
Bob leaves Mary a voicemail (or vice versa);
Bob authors a document where Mary is a co-author;
Bob uploads a document to an intranet site that Mary also uploads to;
Bob tags Mary in a message posted to a computerized social network;
Bob follows Mary on a computerized social network; and
Bob sends an email to a group of which Mary is a member (or vice versa) (The weight of this signal can be in inverse-proportion to the number of other members of that group.).
   Each of these types of interactions can have a different weight, and the weight for each interaction can be decreased over time, as the interaction becomes older. Thus, signals whose timestamp older than a predetermined time period (e.g. more than a month ago) may be discarded. Where multiple user profiles are identified in the computer system as being profiles for the same person, those user profiles can be considered to be a single user profile as used herein. For example, where the computer system includes a computer-readable indication that a user has a user profile for an online email service and also a user profile for a social network, those two user profiles can be considered a single user profile so that interactions for the two user profiles are considered together as a single user profile.

Following are some examples of more static interactions or relationships, which can be updated (such as in the profile directory/groups database 346) as organizational or group changes occur:
Bob works for Mary (or vice versa);
Bob's boss works for Mary (or vice versa); and
Bob is part of a group (as detected through a group email alias or intranet team site membership) and Mary is part of that group.

With this signal data and possibly with corresponding weights, a profile-to-profile score may be computed for a pair of user profiles (e.g., for Bob and Mary), as discussed above.

2. Steps 2, 3, and 4 from Simplified Ranking Example Above: Identifying User-Level Resource Usage for the Active User Profile and Others

A separate set of signals can also be monitored and recorded in the user-level resource usage database 352 for the individual affinity strength indications 258. Such indications 258 can include a record of the user profile that performed the usage activity, and the computer resource 292 (also called a “solution” herein) with which the user profile is interacting. Following are some examples of such signals:
A given user profile has viewed a solution in a gallery but has not acquired it (this can have a negative weight);
A given user profile has been shown a solution in a gallery and has skipped over it and clicked on a different solution (this can have a negative weight);
A given user profile has downloaded a solution from a gallery;
A given user profile has bought a solution from a gallery;
A given user profile has actively inserted or manipulated a solution;
A given user profile has used a solution in a passive way (e.g., viewed package tracking status); and
A given user profile has given a low or high rating for a solution in the solutions gallery rating service (this can have a negative or positive weight).

A record can be created and maintained in the user-level resource usage database 352 containing a list of user to solution mappings, including an affinity strength value 264 for each, where the affinity strength value 264 is the sum of all signals above within a predetermined time window (e.g., the last 30 days). Also, the summing of the signals can include applying different weight values for different corresponding types of signals.

Given a set of users, the computer system can retrieve a set of user→solution mappings with an affinity strength value 264 for each such mapping. As discussed above, the ranking service 250 or 380 can use this computer-readable data along with the connection strength values 268 to create a final per-solution score personalized to the user profile (e.g., for Bob).

For data compliance reasons, the affinity strength values 264, the connection strength values 268, the individual affinity strength indications 258, and the connection strength indications 262 for an organization (e.g., a company) can be stored on servers within that organization's control or on their private cloud, without merging that data with data from all other organizations. Alternatively, the data may be stored in some other manner Also, for purposes of protecting privacy, the use and/or presentation of usage data and/or other data from other user profiles may be limited to situations where permission has been obtained from those other user profiles.

3. Step 5 from Simplified Ranking Example Above: Identifying Global Resource Ranking and Using Query Terms

In a centralized solutions service (e.g. a public app store, or a globally available template service), globally aggregated data, such as global affinity strength indications 260, may be recorded. Examples of signals for the global affinity strength indications 260 may include the following:
The same signals as in Steps 2-4 discussed above, but anonymized and aggregated on a global scale;
Average User ratings (weighted by the number of ratings left by users);
A validation team's annotation of solution quality, e.g. where certain solutions are marked as ‘very valuable’, ‘very usable’, etc.; and
A language boost between the solution's supported language and the listed language for the user profile (for example, Japanese language user profiles can have a greater affinity for solutions in the Japanese language, versus solutions in other languages).

Personalization may be applied at the global level in one or more ways. For example, if the user profile is detected to be using an educational license of a productivity service or belong to an educational organization, the user profile may tend to have an affinity for different solutions compared to user profiles who hold administrative roles and who use large enterprise licenses. So rather than having a single global usage count, a single globally applicable user rating, and a single globally applicable validation team rating, separate ranks may be computed for different user profiles. For example, separate ratings and counts may be generated, maintained, and used for, for example, students' usage count, user ratings from students, and validation team's opinion of value for students. Thus, the computer system may use targeted global affinity values 268, such as pre-defined user profile parameters, including the following: what license type or email identity a user profile has (education, small business, large business, consumer); and whether the user profile has administrative rights.

More nuanced clustering with the global affinity values 268 may be performed if the global resource usage database 306 retains user information. For example, the global resource usage database 306 may store indications that User Profile X bought Solution A, and that User Profile Y bought Solution A and Solution B, rather than simply indications that Solution A was bought 2 times, and Solution B was bought 1 time. Machine learning may be employed by those skilled in the art to determine a list of recommendations. To take a simple example, user profiles who have strong affinity indications for Solution M can also tend to have strong affinity indications for Solution N. Accordingly, if user profile “Bob” visits the solutions gallery and Bob has already acquired Solution M, the Bob user profile can be recommended Solution N because on a global level, it is likely that Bob will use solution N. The computer system can determine such correlations using known statistical analyses on the signal data in the global resource usage database 306, and such correlations can change over time as weights are decreased for older data and newer data becomes available.

The global resource ranking step can thus return a list of globally available solutions for user profile Bob, each with a ranking score reflecting how popular each solution is to users like Bob.

As discussed herein, the resource gallery 370 can be provided with a simple list of relevant solutions (e.g. a templates gallery in a word processing computer application) that the user sees when they first arrive in the resource gallery 370. In obtaining such results, the resource gallery 370 itself may provide a simple search query 368 to the ranking service 380, requesting a listing of computer resources. If the active user profile 254 enters a search query 368 with search terms, however, then known computer searching tools and techniques can augment the ranking score described herein. For example, returned results may include only solutions whose title, description, and/or body contain terms from the query 368. Techniques (e.g., query expansion to account for synonyms and misspellings, etc.) and factors typically used by search engines in narrowing and ranking results can be used. For example, those solutions whose title contains the query term can be preferred over those only whose description contains a keyword etc. In some implementations, the ranking score discussed herein may be combined with standard search engine ranking factors (e.g., weighted and summed with such other factors) to produce the final ranking for the ranked resource data structure 330.

While a number of common techniques for improving relevance of results for information retrieval are discussed in this section, many different combinations of these and/or other pre-existing techniques can be merged with the ranking system 300 discussed herein to further improve performance of the ranking system 300.

4. Step 6 from Simplified Ranking Example Above: Computing Final Rank

As discussed above, in requesting the rank, the resource gallery 370 can send a query 368 to the resource ranking service, where the query is a request for a resource ranking. The request may also include one or more of the following: a user identification for the active user profile, one or more filters (for example, indicating that a user wants to see spreadsheet templates but not word processing templates); a search query with user input search terms or search terms generated by the resource gallery 370 from context; a requested count of the number of results to be returned in the ranked resource data structure; and/or an indication that only solutions with organizational signals (the value from the individual or group affinity strength values 264) above a specified threshold are to be returned.

Such inputs can be used to query results from the internal organizational catalogs and/or from the global solutions catalogs. The results can be filtered to a list of available solutions to which the user has access rights. The solutions ranking service 250 can calculate a score that combines organizational solutions ranking from the affinity strength values 264 with global (possibly personalized) affinity values 266. A final list can be sorted and returned to the solutions gallery in a ranked data structure 272, such as via a Web page or Web service response. The ranked data structure 272 can contain a list of a number (e.g., a maximum of 50) of solutions, including for each solution information such as the title, icon, uniform resource locator, description, download uniform resource locator, etc. For solutions which have strong organizational signals, the ranked data structure 272 may also include additional description as to indications that led to the ranking, such as a count of user profiles that had affinity strength indications for the solution, or names of user profiles that had affinity strength indications for the solution. Such descriptions can allow for novel displays of information along with the listing of resources, with displayed statements such as “Bob, 2 of your co-workers use the Warehouse Reporting add-in, you should use it to. Click here to download . . . . ”

5. Step 7 from Simplified Ranking Example Above: Displaying Results

The tools and techniques herein may simply alter the selection of which solutions to show to users for existing listings of computer resources. For example, when user profile browses images for a word processing application, or templates in a spreadsheet application, or applies a theme in a presentation, or gets an application from an online application store, a user profile from an interconnected group of user profiles (e.g., a user profile for an organization such as a company) can be presented with a more refined and targeted list of computer resources from which to choose (or even a targeted suggestion of a single resource).

Alternate experiences are possible. For example, there may be a filmstrip or category label on a homepage—“See all solutions used in your organization”, where the sort order of that list is according to the ranking described herein. In a different example, an employee who is detected to be new to an organization may launch an online productivity service and see a notification as part of that productivity service's display (e.g., as part of a Web page provided by the productivity service). This may include a statement, such as, “Welcome to the finance group. For best results, get these 4 apps which other people on the Finance group use”, followed by a listing of 4 computer applications that ranked highest for the user profile of the user. Many other different implementations of displays of recommendations from the rankings discussed herein are possible.

### III. Computer Resource Ranking Techniques

Several computer resource ranking techniques will now be discussed. Each of these techniques can be performed in a computing environment. For example, each technique may be performed in a computer system that includes at least one processor and memory including instructions stored thereon that when executed by at least one processor cause at least one processor to perform the technique (memory stores instructions (e.g., object code), and when processor(s) execute(s) those instructions, processor(s) perform(s) the technique). Similarly, one or more computer-readable memory may have computer-executable instructions embodied thereon that, when executed by at least one processor, cause at least one processor to perform the technique. The techniques discussed below may be performed at least in part by hardware logic.

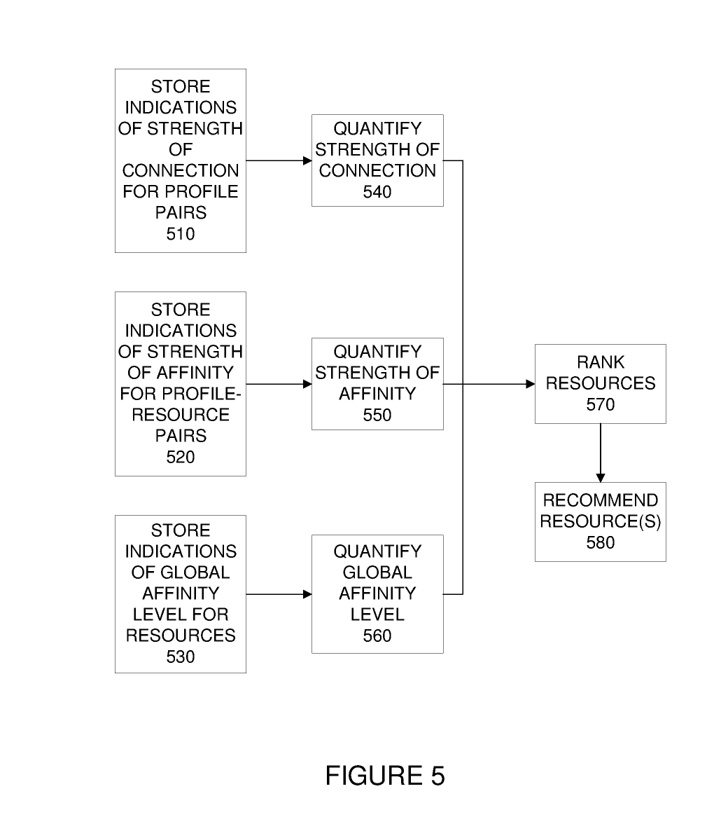

Referring to FIG. 5, a computer resource ranking technique will be discussed. The technique can include storing 510 in a computer system computer-readable indications of strength of connection between user profile pairs for an active computer-readable user profile. Each user profile pair can include the active computer-readable user profile and another computer-readable user profile in an interconnected group of computer-readable user profiles. The technique can also include storing 520 in the computer system indications of strength of affinity within a plurality of user profile-computer resource pairs. Each of the user profile-computer resource pairs can include one of the other computer-readable user profiles and a computer resource in a set of computer resources in the computer system with which the other user profile in the pair can interact. The indications of strength of affinity can each indicate a positive or negative affinity of a user profile for a computer resource, where the user profile and resource are both part of a user profile-computer resource pair. Additionally, the technique can include storing 530 in the computer system indications of a global level of affinity of a global group of user profiles for each computer resource in the set of computer resources. The global group of user profiles can include user profiles outside the interconnected group.

The technique of FIG. 5 can further include quantifying 540 a strength of connection between user profiles in each of the user profile pairs to produce a connection strength value for each user profile pair. The quantifying 540 of the strength of connection can include accessing one or more of the indications of strength of connection. Additionally, a strength of affinity for the user profile-computer resource pairs can be quantified 550 to produce an affinity strength value for each of the user profile-computer resource pairs. The quantifying of the strength of affinity for each user profile-computer resource pair can include accessing one or more of the indications of strength of affinity. Additionally, the technique can include quantifying 560 a global level of affinity of the global group of user profiles for each computer resource in the set of computer resources to produce a global affinity level value for each of the computer resources.

The computer resources can be ranked 570 using the connection strength value for each of the user profile pairs, the affinity strength value for each of the user profile-computer resource pairs, and the global affinity level value for each of the computer resources. This ranking 570 can include generating a ranked data structure in computer memory. One or more of the computer resources can be recommended 580, with the recommending including sending a recommendation generated from the ranked data structure (such as sending all or part of the ranked data structure itself or some other set of data derived from the ranked data structure). The sending may include sending over a computer network from a computer server to a computer client, or sending in some other manner, such as sending to a rendering engine within a stand-alone computer device.

For example, a ranked list of computer resources, or a single listing of a top ranked computer resource, may be sent for presentation on a client computer device. Thus, the recommending 580 may include sending at least a portion of the ranked data structure to a display rendering engine, and the technique may also include controlling a display of the at least a portion of the ranked data structure. The technique may further include deriving a description from the indications of strength of affinity within the user profile-computer resource pairs and the indications of strength of connection between user profile pairs. The recommending 580 can include controlling a display of the description at the same time as the controlling of the display of the at least a portion of the ranked data structure.

In the technique of FIG. 5, the computer resources can include computer applications, and/or other computer resources as discussed herein such as computer services (e.g., remote computer services provided over a computer network), templates, etc. For example, a single resource may be an application, a computer service, or a resource that is a combination of a service and an application. The indications of strength of affinity can include indications of positive affinity and indications of negative affinity, and they may include indications from a plurality of different types of services (e.g., from an email service, a document repository, a text message service, a voicemail service, etc.).

The technique can further include identifying computer resources already used by the active user profile prior to the ranking, and responding to such identification by excluding the identified computer resources already used by the active user profile from the ranked data structure. The technique can also include storing indications of affinity of the active user profile for the computer resources, quantifying strength of affinity of the active user profile for the computer resources to produce an active user profile affinity strength value each of one or more of the computer resources, and using the one or more active user profile affinity strength values in ranking the computer resources. Moreover, the acts can further include receiving a user input computer-readable query for computer resources. The ranking 570 of the computer resources can be performed in response to the receiving of the query, the ranking 570 can use the query, and the recommending 580 can be performed in response to the receiving of the query.

The quantifying 540 of the strength of connection between user profiles can include determining, for each of the other user profiles, whether the other user profile and the active user profile are both in the same sub-group of the interconnected group of user profiles. The quantifying 540 of the strength of connection between user profiles can include determining, for each of the other user profiles, whether the other user profile and the active user profile are connected within a computerized social network. The interconnected group of user profiles may be user profiles for an organizational entity (e.g., a company, non-profit organization, an association, etc.), and the user profiles in the interconnected group of user profiles can be connected to each other by being connected to a representation of the organizational entity.

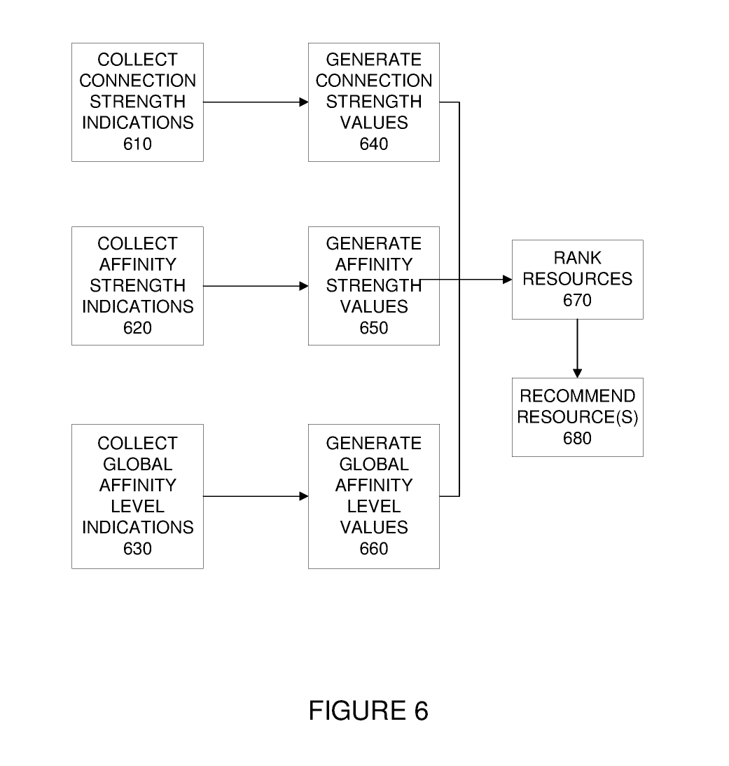

Referring now to FIG. 6, another computer resource ranking technique will be discussed. The technique can include collecting 610 indications of strength of connection between user profile pairs for an active user profile, with each user profile pair including the active user profile and another user profile for an interconnected group of user profiles. The technique can also include collecting 620 indications of strength of affinity within user profile-computer resource pairs, with each of the user profile-computer resource pairs including one of the other user profiles and a computer resource. The computer resources may be hardware resources and/or software resources, such as templates, computer applications, etc. The indications of strength of affinity can each indicate a positive or negative affinity of a user profile for respective a computer resource in a pair. The technique can also include collecting 630 computer-readable indications of a global level of affinity of a global group of user profiles for each computer resource in the set of computer resources. The global group of user profiles can include user profiles outside the interconnected group.

The technique can further include generating 640 in computer memory a connection strength value for each of the user profile pairs. This generating 640 can include quantifying the strength of connection between user profiles in each of the user profile pairs, which can include accessing the connection strength indications. The technique can also include generating 650 in computer memory an affinity strength value for each of the user profile-computer resource pairs. The generating 650 of each affinity strength value can include quantifying the strength of affinity for each of the user profile-computer resource pairs, which can include accessing the affinity strength indications.

The technique can further include generating 660 in computer memory a global affinity level value for each of the computer resources. The generating 660 of the global affinity level value can include quantifying the global level of affinity of the global group of user profiles for each computer resource in the set of computer resources using the indications of the global level of affinity.

The computer resources can be ranked 670 using the connection strength value for each of the user profile pairs, the affinity strength value for each of the user profile-computer resource pairs, and the global affinity level value for each of the computer resources. The ranking can include generating a computer-readable ranked data structure in computer memory. The technique can further include recommending 680 one or more of the computer resources for the active user profile, with the recommending including sending a computer-readable recommendation generated from the ranked data structure.

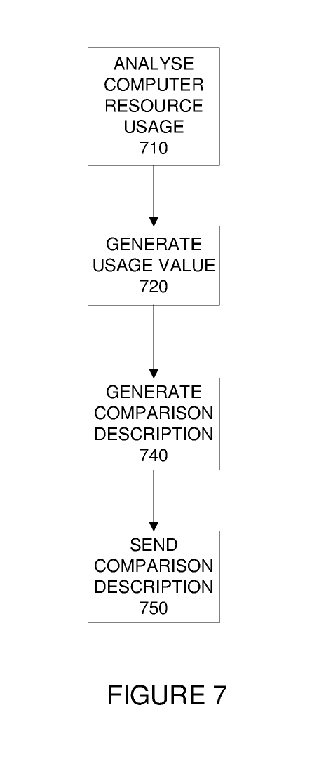

Referring now to FIG. 7, yet another computer resource ranking technique will be discussed. The technique can include analyzing 710 usage of a computer resource by a plurality of computer-readable user profiles to produce a plurality of indications of usage by the user profiles. Each of the indications of usage can be connected to an associated user profile that initiated the usage and to the computer resource. A value representing the usage of the computer resource by the plurality of computer-readable user profiles in a selected sub-group of user profiles can be generated 720, with the sub-group being part of a group of user profiles having a plurality of sub-groups. A description of a comparison of the value for the selected sub-group with a usage value for another sub-group in the group of user profiles can be generated 740. Also, the description can be sent 750 in response to a computer-readable request received via the computer system. As an example, the description may be a description that provides a group ranking value for the resource for the selected sub-group, and a group ranking value for the resource for the other sub-group. Thus, the description can include both ranking values to be presented. As another example, a more active comparison may be conducted when generating the comparison description, such as calculating a value that represents a difference between ranking values for the two groups, generating a chart that compares ranking values for the resource from the two groups, etc.

The sub-groups of the FIG. 7 technique can be sub-groups for an organizational entity. The technique of FIG. 7 can further include storing an indication of one of the sub-groups to which each of the user profiles belongs. The generating 720 of the value can include generating the value for usage by user profiles belonging to the selected sub-group of the organization and excluding from the generation of the value usage by user profiles that do not belong to the selected sub-group.

### IV. Aspects of Certain Embodiments

Aspects of certain embodiments will now be discussed. In one aspect, a computer system can include means for storing in the computer system computer-readable indications of strength of connection between user profile pairs for an active computer-readable user profile, with each user profile pair including the active computer-readable user profile and another computer-readable user profile in an interconnected group of computer-readable user profiles. The computer system can also include means for storing in the computer system computer-readable indications of strength of affinity within a plurality of user profile-computer resource pairs, with each of the user profile-computer resource pairs including one of the other computer-readable user profiles and a computer resource in a set of computer resources in the computer system with which the other computer-readable user profile in the user profile-computer resource pair can interact, with the indications of strength of affinity each indicating a positive or negative affinity of a computer-readable user profile for a computer resource in a user profile-computer resource pair. The computer system can further include means for storing in the computer system computer-readable indications of a global level of affinity of a global group of user profiles for each computer resource in the set of computer resources, with the global group of user profiles including user profiles outside the interconnected group of computer-readable user profiles.

Moreover, the computer system can include means for quantifying a strength of connection between user profiles in each of the user profile pairs to produce a connection strength value for each user profile pair, with the quantifying of the strength of connection including accessing one or more of the indications of strength of connection. The computer system can also include means for quantifying a strength of affinity for the user profile-computer resource pairs to produce an affinity strength value for each of the user profile-computer resource pairs, with the quantifying of the strength of affinity for each user profile-computer resource pair including accessing one or more of the indications of strength of affinity. The computer system can also include means for quantifying a global level of affinity of the global group of user profiles for each computer resource in the set of computer resources to produce a global affinity level value for each of the computer resources, and means for ranking the computer resources using the connection strength value for each of the user profile pairs, the affinity strength value for each of the user profile-computer resource pairs, and the global affinity level value for each of the computer resources, with the ranking including generating a computer-readable ranked data structure in computer memory. The computer system can further include means for recommending one or more of the computer resources for the active user profile, with the recommending including sending a computer-readable recommendation generated from the ranked data structure.

The computer resources can include various resources such as computer applications, computer services, documents, templates, and/or other resources. The sending of the recommendation can include sending at least a portion of the ranked data structure to a display rendering engine, wherein the recommending includes controlling a display of the at least a portion of the ranked data structure, and wherein the computer system further includes means for deriving a description from the indications of strength of affinity within the user profile-computer resource pairs and the indications of strength of connection between user profile pairs, and wherein the recommending includes controlling a display of the description at the same time as the controlling of the display of the at least a portion of the ranked data structure.

The computer system can further include the following: means for identifying computer resources already used by the active user profile prior to the ranking, and means for excluding the identified computer resources already used by the active user profile from the ranked data structure; means for storing indications of affinity of the active user profile for the computer resources; means for quantifying strength of affinity of the active user profile for the computer resources to produce an active user profile affinity strength value each of one or more of the computer resources; means for using the one or more active user profile affinity strength values in ranking the computer resources; and/or means for receiving a user input computer-readable query for computer resources, wherein the ranking of the computer resources is in response to the receiving of the query, wherein the ranking uses the query in addition to using the connection strength value for each of the user profile pairs, the affinity strength value for each of the user profile-computer resource pairs, and the global affinity level value for each of the computer resources, and wherein the recommending is in response to the receiving of the query.

The quantifying of the strength of connection between user profiles can include determining, for each of the other user profiles, whether the other user profile and the active user profile are connected within a computerized social network. Also, the interconnected group of user profiles can be user profiles for an organizational entity, and the user profiles in the interconnected group of user profiles can be connected to each other by being connected to a representation of the organizational entity.

In another aspect, a computer-implemented method or technique can include collecting, via a computer system, computer-readable indications of strength of connection between user profile pairs for an active computer-readable user profile, with each user profile pair including the active computer-readable user profile and another computer-readable user profile for an interconnected group of computer-readable user profiles. The technique can further include collecting, via a computer system, computer-readable indications of strength of affinity within a plurality of user profile-computer resource pairs, with each of the user profile-computer resource pairs including one of the other computer-readable user profiles and a computer resource in a set of computer resources in the computer system with which the other computer-readable user profile in the user profile-computer resource pair can interact, the indications of strength of affinity each indicating a positive or negative affinity of a computer-readable user profile for a computer resource in a user profile-computer resource pair. Moreover, the technique can include collecting, via a computer system, computer-readable indications of a global level of affinity of a global group of user profiles for each computer resource in the set of computer resources, the global group of user profiles including user profiles outside the interconnected group of computer-readable user profiles.

Moreover, the technique can include generating in computer memory a connection strength value for each of the user profile pairs, the generating of the connection strength value including quantifying the strength of connection between user profiles in each of the user profile pairs, and the quantifying of the strength of connection using one or more of the indications of strength of connection. The technique can also include generating in computer memory an affinity strength value for each of the user profile-computer resource pairs, the generating of each affinity strength value including quantifying the strength of affinity for the user profile-computer resource pairs, and the quantifying of the strength of affinity for each user profile-computer resource pair including accessing one or more of the indications of strength of affinity. The technique can further include generating in computer memory a global affinity level value for each of the computer resources, the generating of the global affinity level value including quantifying the global level of affinity of the global group of user profiles for each computer resource in the set of computer resources using the indications of the global level of affinity. Additionally, the technique can include ranking the computer resources using the connection strength value for each of the user profile pairs, the affinity strength value for each of the user profile-computer resource pairs, and the global affinity level value for each of the computer resources, the ranking including generating a computer-readable ranked data structure in computer memory. Additionally, the technique can include recommending one or more of the computer resources for the active user profile, with the recommending including sending a computer-readable recommendation generated from the ranked data structure.

In another aspect, a technique can include analyzing, via a computer system, usage of a computer resource by a plurality of computer-readable user profiles to produce a plurality of indications of usage by the user profiles, each of the indications of usage being connected to an associated user profile that initiated the usage and to the computer resource. The technique can further include generating, via the computer system, a value representing the usage of the computer resource by the plurality of computer-readable user profiles in a selected interconnected sub-group of user profiles, the selected sub-group being part of an interconnected group of user profiles having a plurality sub-groups. Additionally, the technique can include generating, via the computer system, a value representing the usage of the computer resource by the plurality of computer-readable user profiles in a selected interconnected sub-group of user profiles, the selected sub-group being part of an interconnected group of user profiles having a plurality sub-groups. The technique also can include generating, via the computer system, a description of a comparison of the value for the selected sub-group with a usage value for another sub-group in the group of user profiles. Additionally, the technique can include sending, via the computer system, the description of the comparison in response to a computer-readable request received via the computer system.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

I/We claim:

1. A computer system comprising:
at least one processor; and
memory comprising instructions stored thereon that when executed by at least one processor cause at least one processor to perform acts comprising:
storing in the computer system computer-readable indications of strength of connection between user profile pairs for an active computer-readable user profile, with each user profile pair comprising the active computer-readable user profile and another computer-readable user profile in an interconnected group of computer-readable user profiles;
storing in the computer system computer-readable indications of strength of affinity within a plurality of user profile-computer resource pairs, with each of the user profile-computer resource pairs comprising one of the other computer-readable user profiles and a computer resource in a set of computer resources in the computer system with which the other computer-readable user profile in the user profile-computer resource pair can interact, the indications of strength of affinity each indicating a positive or negative affinity of a computer-readable user profile for a computer resource in a user profile-computer resource pair;
storing in the computer system computer-readable indications of a global level of affinity of a global group of user profiles for each computer resource in the set of computer resources, the global group of user profiles comprising user profiles outside the interconnected group of computer-readable user profiles;
quantifying a strength of connection between user profiles in each of the user profile pairs to produce a connection strength value for each user profile pair, the quantifying of the strength of connection comprising accessing one or more of the indications of strength of connection;
quantifying a strength of affinity for the user profile-computer resource pairs to produce an affinity strength value for each of the user profile-computer resource pairs, the quantifying of the strength of affinity for each user profile-computer resource pair comprising accessing one or more of the indications of strength of affinity;
quantifying a global level of affinity of the global group of user profiles for each computer resource in the set of computer resources to produce a global affinity level value for each of the computer resources;
ranking the computer resources using the connection strength value for each of the user profile pairs, the affinity strength value for each of the user profile-computer resource pairs, and the global affinity level value for each of the computer resources, the ranking comprising generating a computer-readable ranked data structure in computer memory; and
recommending one or more of the computer resources for the active user profile, with the recommending comprising sending a computer-readable recommendation generated from the ranked data structure.

2. The computer system of claim 1, wherein the computer resources comprise computer applications.

3. The computer system of claim 1, wherein the computer resources comprise computer services.

4. The computer system of claim 1, wherein the sending of the computer-readable recommendation comprises sending at least a portion of the ranked data structure to a display rendering engine.

5. The computer system of claim 4, wherein the recommending comprises controlling a display of the at least a portion of the ranked data structure.

6. The computer system of claim 5, wherein the acts further comprise deriving a description from the indications of strength of affinity within the user profile-computer resource pairs and the indications of strength of connection between user profile pairs, and wherein the recommending comprises controlling a display of the description at the same time as the controlling of the display of the at least a portion of the ranked data structure.

7. The computer system of claim 1, wherein the indications of strength of affinity comprise indications from a plurality of different types of services.

8. The computer system of claim 1, wherein the acts further comprise identifying computer resources already used by the active user profile prior to the ranking, and excluding the identified computer resources already used by the active user profile from the ranked data structure.

9. The computer system of claim 1, wherein the acts further comprise storing indications of affinity of the active user profile for the computer resources, quantifying strength of affinity of the active user profile for the computer resources to produce an active user profile affinity strength value each of one or more of the computer resources, and using the one or more active user profile affinity strength values in ranking the computer resources.

10. The computer system of claim 1, wherein the acts further comprise receiving a user input computer-readable query for computer resources, wherein the ranking of the computer resources is performed in response to the receiving of the query, wherein the ranking uses the query in addition to using the connection strength value for each of the user profile pairs, the affinity strength value for each of the user profile-computer resource pairs, and the global affinity level value for each of the computer resources, and wherein the recommending is performed in response to the receiving of the query.

11. The computer system of claim 1, wherein quantifying the strength of connection between user profiles comprises determining, for each of the other user profiles, whether the other user profile and the active user profile are connected within a computerized social network.

12. The computer system of claim 1, wherein the interconnected group of user profiles are user profiles for an organizational entity, and wherein the user profiles in the interconnected group of user profiles are connected to each other by being connected to a representation of the organizational entity.

13. A computer-implemented method comprising:
collecting, via a computer system, computer-readable indications of strength of connection between user profile pairs for an active computer-readable user profile, with each user profile pair comprising the active computer-readable user profile and another computer-readable user profile for an interconnected group of computer-readable user profiles;
collecting, via a computer system, computer-readable indications of strength of affinity within a plurality of user profile-computer resource pairs, with each of the user profile-computer resource pairs comprising one of the other computer-readable user profiles and a computer resource in a set of computer resources in the computer system with which the other computer-readable user profile in the user profile-computer resource pair can interact, the indications of strength of affinity each indicating a positive or negative affinity of a computer-readable user profile for a computer resource in a user profile-computer resource pair;
collecting, via a computer system, computer-readable indications of a global level of affinity of a global group of user profiles for each computer resource in the set of computer resources, the global group of user profiles comprising user profiles outside the interconnected group of computer-readable user profiles;
generating in computer memory a connection strength value for each of the user profile pairs, the generating of the connection strength value comprising quantifying the strength of connection between user profiles in each of the user profile pairs, and the quantifying of the strength of connection using one or more of the indications of strength of connection;
generating in computer memory an affinity strength value for each of the user profile-computer resource pairs, the generating of each affinity strength value comprising quantifying the strength of affinity for the user profile-computer resource pairs, and the quantifying of the strength of affinity for each user profile-computer resource pair comprising accessing one or more of the indications of strength of affinity;
generating in computer memory a global affinity level value for each of the computer resources, the generating of the global affinity level value comprising quantifying the global level of affinity of the global group of user profiles for each computer resource in the set of computer resources using the indications of the global level of affinity;
ranking the computer resources using the connection strength value for each of the user profile pairs, the affinity strength value for each of the user profile-computer resource pairs, and the global affinity level value for each of the computer resources, the ranking comprising generating a computer-readable ranked data structure in computer memory; and
recommending one or more of the computer resources for the active user profile, with the recommending comprising sending a computer-readable recommendation generated from the ranked data structure.

14. The computer-implemented method of claim 13, wherein the computer resources comprise computer software resources.

15. The computer-implemented method of claim 14, wherein the computer resources comprise computer applications.

16. A computer system comprising:
at least one processor;
memory comprising instructions stored thereon that when executed by at least one processor cause at least one processor to perform acts comprising:
analyzing, via a computer system, usage of a computer resource by a plurality of computer-readable user profiles to produce a plurality of indications of usage by the user profiles, each of the indications of usage being connected to an associated user profile that initiated the usage and to the computer resource;
generating, via the computer system, a value representing the usage of the computer resource by the plurality of computer-readable user profiles in a selected interconnected sub-group of user profiles, the selected sub-group being part of an interconnected group of user profiles having a plurality sub-groups;
generating, via the computer system, a description of a comparison of the value for the selected sub-group with a usage value for another sub-group in the group of user profiles; and
sending, via the computer system, the description of the comparison in response to a computer-readable request received via the computer system.

17. The computer system of claim 16, wherein the sub-groups are sub-groups for an organizational entity, wherein the acts further comprise storing an indication of one of the sub-groups to which each of the user profiles belongs, and wherein generating of the value comprises generating the value for usage by user profiles belonging to the selected sub-group of the organization and excluding from the generation of the value usage by user profiles that do not belong to the selected sub-group.

18. The computer system of claim 16, wherein the acts are performed at least in part by hardware logic.

19. The computer system of claim 16, wherein the computer resource comprises a computer application.

20. The computer system of claim 16, wherein the acts further comprise displaying the description of the comparison.
